(19) United States
(12) Patent Application Publication
(10) Pub. No.: US 2024/0304380 A1
(43) Pub. Date: Sep. 12, 2024

(54) COIL COMPONENT

(71) Applicant: SAMSUNG ELECTRO-MECHANICS CO., LTD., Suwon-si (KR)

(72) Inventors: Soon Kwang KWON, Suwon-si (KR); Dong Jin LEE, Suwon-si (KR); Dong Hwan LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/385,085

(22) Filed: Oct. 30, 2023

(30) Foreign Application Priority Data
Mar. 9, 2023 (KR) 10-2023-0030906

(51) Int. Cl. H01F 27/32; H01F 27/28

(52) U.S. Cl. CPC H01F 27/324; H01F 27/2847; H01F 2027/329

(57) ABSTRACT

A coil component includes a support member; a coil portion including at least one of first and second coil patterns respectively disposed on one surface and the other surface of the support member; and a body embedding the support member and the coil portion, wherein at least one of the first and second coil patterns includes a second conductive layer and a first conductive layer disposed between the second conductive layer and the support member, and wherein the coil portion further includes an internal insulating wall buried in the second conductive layer.

### CROSS-REFERENCE TO RELATED APPLICATION (S)

This application claims benefit of priority to Korean Patent Application No. 10-2023-0030906 filed on Mar. 9, 2023 in the Korean Intellectual Properties Office, the disclosure of which is incorporated herein by reference in its entirety.

### BACKGROUND

### 1. Technical Field

The present disclosure relates to a coil component.

### 2. Description of Related Art

An inductor, a coil component, may be a passive electronic component used in electronic devices along with a resistor and a capacitor.

In a thin film coil component, a coil component, a coil pattern may be formed on a support member by a thin film process such as a plating process, a body may be formed by laminating one or more magnetic composite sheets on a support member on which a coil pattern is formed, and an external electrode may be formed on the body.

Inductance of a coil pattern may increase as the total number of turns of the coil pattern increases, and the total number of turns of the coil pattern in a unit area may increase as a width of the coil pattern decreases.

Energy loss in a coil pattern may be further reduced as equivalent series resistance of the coil pattern is reduced, and equivalent series resistance of the coil pattern in a unit area may be reduced as a thickness of the coil pattern increases.

Accordingly, it may be important to increase an aspect ratio (A/R), which is a ratio of thickness/width of a coil pattern, or to implement a coil pattern to have an increased thickness, and a coil component having a coil pattern having a high aspect ratio or an increased thickness may be easily used as a power inductor or HF inductor requiring high energy efficiency.

### SUMMARY

An embodiment of the present disclosure is to provide a coil component which may be advantageous for optimizing frequency performance.

According to an embodiment of the present disclosure, a coil component includes a support member; a coil portion disposed on at least one of one surface and the other surface of the support member; and a body embedding the support member and the coil portion, wherein the coil portion includes a second conductive layer and a first conductive layer disposed between the second conductive layer and the support member, and wherein the coil portion further includes an internal insulating wall buried in the second conductive layer.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a coil component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an enlarged cross-sectional diagram illustrating region A in FIG. 2;

FIGS. 5A to 5C are cross-sectional diagrams illustrating a method of manufacturing a coil component according to an embodiment of the present disclosure;

FIG. 6 is a cross-sectional diagram illustrating a plurality of internal insulating walls of a coil component according to an embodiment of the present disclosure;

FIGS. 7A and 7B are cross-sectional diagrams illustrating a method of manufacturing a coil component illustrated in FIG. 6;

FIG. 8 is a plan diagram illustrating a coil component according to an embodiment of the present disclosure;

FIG. 9 is a cross-sectional diagram illustrating a structure in which an internal insulating wall of a coil component divides a coil pattern according to an embodiment of the present disclosure;

FIGS. 10A and 10B are graphs indicating a resistance value according to a frequency of a current flowing through a coil component according to an embodiment of the present disclosure; and

FIGS. 11A to 11D are cross-sectional diagrams illustrating various shapes of an internal insulating wall of a coil component according to an embodiment of the present disclosure.

### DETAILED DESCRIPTION

The terms used in the embodiments are used to simply describe an embodiment, and are not intended to limit the present disclosure. A singular term includes a plural form unless otherwise indicated. The terms, “include,” “comprise,” “may be configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “disposed on,” and the like, may indicate that an element is disposed on or beneath an object, and may not necessarily mean that the element is disposed on the object with reference to a gravity direction.

Terms such as “coupled to,” “combined with,” and the like, may not only indicate that elements are directly and physically in contact with each other, but also include the configuration in which the other element is interposed between the elements such that the elements are also in contact with the other component.

The size and thickness of each component in the lead-outs may be arbitrarily indicated for ease of description, and thus, the present disclosure is not necessarily limited to the illustrated examples.

In the drawings, an X-direction is a first direction or a length direction, a Y-direction is a second direction or a width direction, a Z-direction is a third direction or a thickness direction.

Hereinafter, a coil component according to an embodiment will be described in detail with reference to the accompanying lead-outs, and in the description with reference to the accompanying lead-outs, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

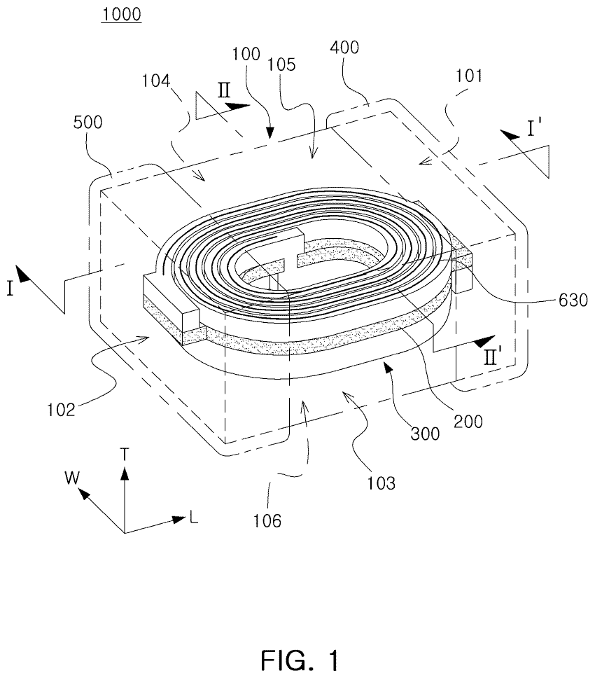

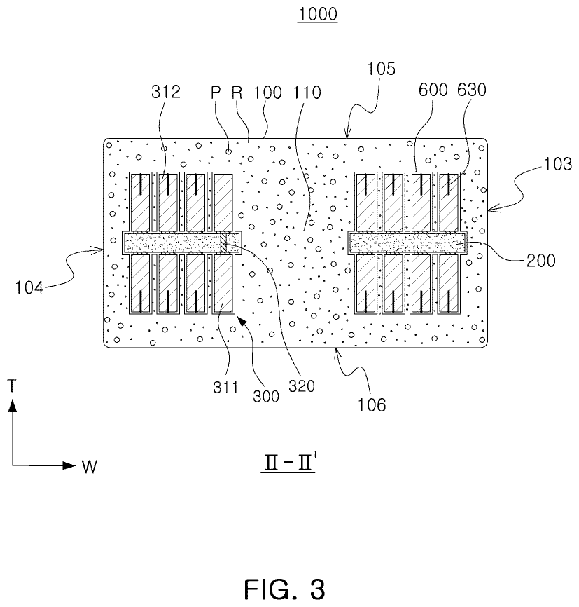

Referring to FIGS. 1 to 3, a coil component 1000 according to the embodiment may include a body 100, a support member 200 and a coil portion 300, and may further include at least one of external electrodes 400 and 500 and an insulating film 600.

The body 100 may form an exterior of the coil component 1000 in the embodiment, and the support member 200 and the coil portion 300 may be buried in the body 100. The body 100 may have a hexahedral shape.

With reference to the directions illustrated in FIGS. 1, 2, and 3, the body 100 may include a first surface 101 and a second surface 102 opposing each other in a length direction L, a third surface 103 and a fourth surface 104 opposing each other in a width direction W, and a fifth surface 105 and a sixth surface 106 opposing each other in a thickness direction T. The first to fourth surfaces 101, 102, 103, and 104 of the body 100 may be walls of the body 100 connecting the fifth surface 105 to the sixth surface 106 of the body 100. In the description below, both end surfaces of the body 100 may refer to the first surface 101 and the second surface 102 of the body 100, both side surfaces of the body 100 may refer to the third surface 103 and the fourth surface 104 of the body 100, one surface of the body 100 may refer to the sixth surface 106 of the body 100 and the other surface of the body 100 may refer to the fifth surface 105 of the body 100. Also, in the description below, the upper surface and the lower surface of the body 100 may refer to the fifth surface 105 and the sixth surface 106 of the body 100, respectively, determined with respect to the directions in FIGS. 1 to 3.

For example, the body 100 may be formed such that the coil component 1000 according to the embodiment in which the external electrodes 400 and 500 are formed may have a length of 1.035 mm, a width of 0.76 mm, and a thickness of 0.615 mm, but an embodiment thereof is not limited thereto. To this end, the body 100 may be formed to have a length of 0.975 mm, a width of 0.705 mm to 0.72 mm, and a thickness of 0.58 mm, but an embodiment thereof is not limited thereto.

The body 100 may include magnetic powder P and insulating resin R. Specifically, the body 100 may be formed by laminating one or more magnetic composite sheets including insulating resin R and insulating resin R dispersed in magnetic powder P, and curing the magnetic composite sheet. However, the body 100 may have a structure other than a structure in which magnetic powder P is dispersed in insulating resin R. For example, the body 100 may be formed of a magnetic material such as ferrite.

Magnetic powder P may be, for example, ferrite or magnetic metal powder.

The ferrite powder may include, for example, at least one material of a spinel ferrite such as an Mg—Zn ferrite, an Mn—Zn ferrite, an Mn—Mg ferrite, a Cu—Zn ferrite, an Mg—Mn—Sr ferrite, an Ni—Zn ferrite, and the like, a hexagonal ferrite such as a Ba—Zn ferrite, a Ba—Mg ferrite, a Ba—Ni ferrite, a Ba—Co ferrite, a Ba—Ni—Co ferrite, and the like, a garnet ferrite such as a Y ferrite, and a Li ferrite.

The magnetic metal powder may include one or more selected from a group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be one or more of a pure iron powder, a Fe—Si alloy powder, a Fe—Si—Al alloy powder, a Fe—Ni alloy powder, a Fe—Ni—Mo alloy powder, Fe—Ni—Mo—Cu alloy powder, a Fe—Co alloy powder, a Fe—Ni—Co alloy powder, a Fe—Cr alloy powder, a Fe—Cr—Si alloy powder, a Fe—Si—Cu—Nb alloy powder, a Fe—Ni—Cr alloy powder, and a Fe—Cr—Al alloy powder.

The magnetic metal powder may be amorphous or crystalline. For example, the magnetic metal powder may be a Fe—Si—B—Cr amorphous alloy powder, but an embodiment of the magnetic metal powder is not limited thereto.

Each particle of the ferrite and the magnetic metal powder may have an average diameter of 0.1 μm to 30 μm, but an example of the average diameter is not limited thereto.

The body 100 may include two or more types of magnetic powder P dispersed in the insulating resin R. The different types of the magnetic powder P may indicate that one of an average diameter, a composition, crystallinity, and a form of the different types of the magnetic powder P disposed in the insulating resin R is different.

The insulating resin R may include one of an epoxy, a polyimide, a liquid crystal polymer, or mixtures thereof, but the example of the resin is not limited thereto.

The body 100 may include a core 110 penetrating the support member 200 and the coil portion 300. The core 110 may be formed by filling a through-hole of the coil portion 300 with a portion of a magnetic composite sheet, but an embodiment thereof is not limited thereto.

The support member 200 may be buried in the body 100. The support member 200 may support the coil portion 300.

The support member 200 may be formed of an insulating material including a thermosetting insulating resin such as epoxy resin, a thermoplastic insulating resin such as polyimide, or a photosensitive insulating resin, or an insulating material impregnated with a reinforcement material such as glass fibers or inorganic fillers in the insulating resins. For example, the support member 200 may be formed of an insulating material such as prepreg, Ajinomoto build-up film (ABF), FR-4, bismaleimide triazine (BT) film, and photoimagable dielectric (PID) film, but an embodiment thereof is not limited thereto.

As an inorganic filler, at least one or more selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), carbonic acid Calcium (CaCO₃), magnesium carbonate (MgCO₃), magnesium oxide (MgO), boron nitride (BN), aluminum borate (ALBO₃), barium titanate (BaTiO₃) and calcium zirconate (CaZrO₃) may be used.

When the support member 200 is formed of an insulating material including a reinforcement material, the support member 200 may provide improved rigidity. When the support member 200 is formed of an insulating material not including glass fibers, the support member 200 may be advantageous in reducing the thickness of the component. When the support member 200 is formed of an insulating material including a photosensitive insulating resin, the number of processes for forming the coil portion 300 may be reduced, which may be advantageous in reducing production costs and forming fine vias. The thickness of the support member 200 may be greater than 20 μm and less than 40 μm, more preferably greater than 25 μm and less than 35 μm, but an embodiment thereof is not limited thereto.

The coil portion 300 may include first and second coil patterns 311 and 312 having a planar spiral shape, disposed on the support member 200, may be buried in the body 100 and may exhibit properties of the coil component. For example, when the coil component 1000 of the embodiment is used as a power inductor, the coil portion 300 may maintain an output voltage by storing an electric field as a magnetic field, thereby stabilizing power of an electronic device.

The coil portion 300 may include first and second coil patterns 311 and 312 and vias 320. Specifically, with respect to the directions in FIGS. 1, 2 and 3, the first coil pattern 311 may be disposed on the lower surface of the support member 200 opposing the sixth surface 106 of the body 100, and the second coil pattern 312 may be disposed on the upper surface of the support member 200. The via 320 may pass through the support member 200 and may be in contact with and connected to the first coil pattern 311 and the second coil pattern 312. Accordingly, the coil portion 300 may function as a coil in which one or more turns are formed around the core 110.

The via 320 may include at least one conductive layer. For example, when the via 320 is formed by electroplating, the via 320 may include a seed layer formed on the internal wall of the via hole penetrating the support member 200 and an electroplating layer filling the via hole in which the seed layer is formed. The seed layer of the via 320 and the seed layer (the first conductive layer) for forming the first and second coil patterns 311 and 312 may be formed together in the same process and integrated with each other, or may be formed in different processes such that a boundary may be formed between the patterns. The via 320 may include conductive material such as copper (Cu), aluminum (Al), silver (Ag), tin (Sn), gold (Au), nickel (Ni), lead (Pb), titanium (Ti), chromium (Cr), molybdenum (Mo) or an alloy thereof.

The first and second lead-out patterns 311e and 312e of the first and second coil patterns 311 and 312 may be connected to the first and second external electrodes 400 and 500, respectively. For example, the first lead-out pattern 311e of the first coil pattern 311 may be exposed to the first surface 101 of the body 100 and may be in contact with and connected to the first external electrode 400. For example, the second lead-out pattern 312e of the second coil pattern 312 may be exposed to the second surface 102 of the body 100 and may be in contact with and connected to the second external electrode 500.

The external electrodes 400 and 500 may have a single layer structure or a multilayer structure. For example, the first external electrode 400 may include a first layer including copper (Cu), a second layer disposed on the first layer and including nickel (Ni), and a third layer disposed on the second layer and including tin (Sn). Here, each of the first and third layers may be formed by plating, but an embodiment thereof is not limited thereto. As another example, the first external electrode 400 may include a resin electrode including conductive powder such as silver (Ag) and a resin, and a nickel (Ni)/tin (Sn) plating layer plated on the resin electrode. The external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but an embodiment thereof is not limited thereto.

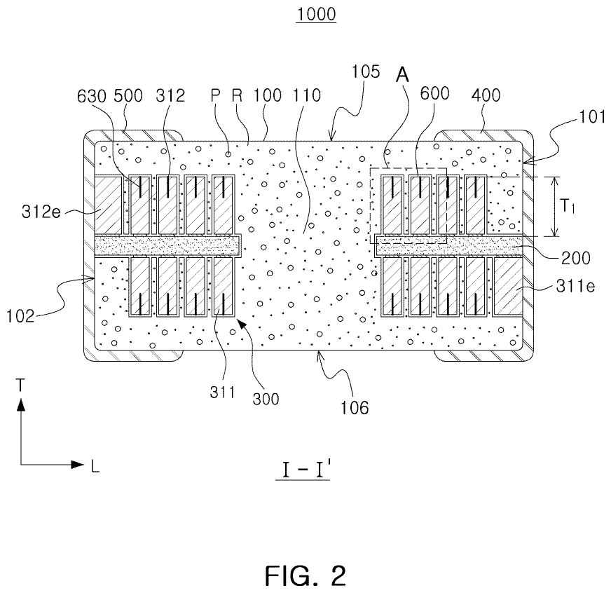

Each of the first and second coil patterns 311 and 312 may have a shape of a planar spiral in which at least one turn is formed around the core 110 as an axis. For example, the first coil pattern 311 may form at least one turn around the core 110 on the lower surface of the support member 200 with respect to the direction in FIG. 2.

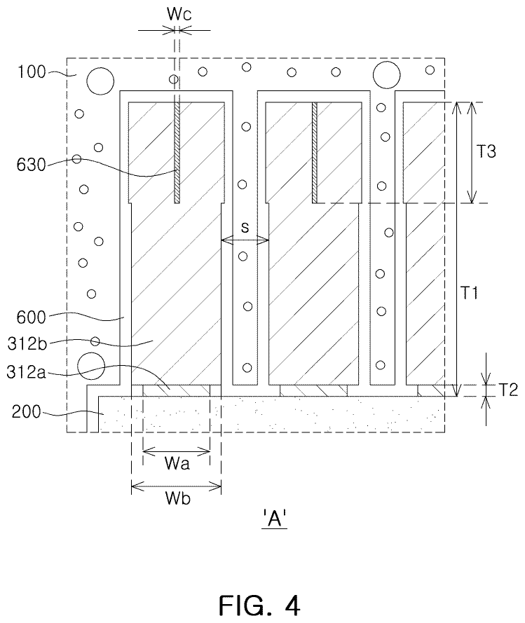

Referring to FIGS. 2 and 4, the second coil pattern 312 may include a first conductive layer 312a disposed in contact with one surface of the support member 200, and a second conductive layer 312b disposed on the first conductive layer 312a spaced apart from one surface of the support member 200, and the second conductive layer 312b may correspond to the aforementioned innermost turn 312i, the intermediate turn 312m, and the outermost turn. In the description below, to avoid overlap, the first conductive layer and the second conductive layer will be described centering on the second coil pattern 312, but this description may be applied to the first coil pattern 311.

The first conductive layer 312a may be formed from a seed layer for forming the second conductive layer 312b by electroplating. The seed layer may be formed by performing electroless plating or sputtering on the support member 200. When the seed layer is formed by sputtering, at least a portion of a material included in the first conductive layer 312a may penetrate into the support member 200, which may be confirmed by a difference in concentrations of the metal materials included in the first conductive layer 312a in the support member 200 in the thickness direction T of the body 100.

The first conductive layer 312a may include at least one of molybdenum (Mo), titanium (Ti), chromium (Cr), and copper (Cu). The first conductive layer 312a may have a multilayer structure, such as molybdenum (Mo)/titanium (Ti), but an embodiment thereof is not limited thereto.

The second conductive layer 312b may be formed by forming a plating resist having an opening in the seed layer and filling the opening of the plating resist with a conductive material by electroplating. The second conductive layer 312b may include copper (Cu). For example, the second conductive layer 312b may be formed of copper (Cu) through electrolytic copper plating, but an embodiment thereof is not limited thereto.

The first and second conductive layers 312a and 312b may include different metal materials. Here, the configuration in which metal materials are different may include that the composition ratio (based on mol ratio) is different, and may also include that a metal material included in one of the first and second conductive layers (312a, 312b) is included in a lower molar ratio in the other. For example, when the material most included in the second conductive layer 312b is copper (Cu) or an alloy of copper, the first conductive layer 312a may include a material different from copper (Cu) and different from alloys of copper (e.g. molybdenum (Mo), titanium (Ti) and chromium (Cr)) by more than 50% (based on mol) and less than 100%, or may include copper (Cu) or an alloy of copper by 0% or more and less than 50% (based on mol). Here, the second conductive layer 312b may also include a portion of metal materials (e.g., molybdenum (Mo), titanium (Ti) and chromium (Cr)) other than copper (Cu). The second conductive layer 312b may be formed as a single layer through a single electroplating process or may include a plurality of layers through a plurality of electroplating processes.

Referring to FIGS. 1, 2, 3 and 4, the coil portion 300 may further include an internal insulating wall 630 surrounded by the second conductive layer 312b and overlapping one portion of the second conductive layer 312b. The internal insulating wall 630 may be buried in the second conductive layer 312b. Here, the overlapping direction may be a direction (e.g., T direction) in which one surface of the support member 200 and the other surface oppose each other. Accordingly, a thickness T3 of the internal insulating wall 630 may be smaller than a thickness (T1−T2) of the second conductive layer 312b.

Accordingly, a surface area of at least one of the first and second coil patterns 311 and 312 may be widened. For the skin effect, density of a current flowing through the first and second coil patterns 311 and 312 may be more concentrated in the surface area as a frequency of the current increases. As the frequency of the current increases, a difference in density between a portion having a high current density and a portion having a low current density within the first and second coil patterns 311 and 312 may also increase.

In other words, when the frequency of the current increases, the effective shape of the first and second coil patterns 311 and 312 may be close to a shape (e.g., a hollow shape) in which centers of the first and second coil patterns 311 and 312 are hollow. As the frequency of the current increases, the ratio of the diameter of the hollow portion of the center may increase. An increase in the ratio of the diameter of the hollow portion of the shape may correspond to a decrease in the width of a path through which current flows in a resistance model, and resistance may be inversely proportional to the width of the path. Accordingly, effective resistance of the first and second coil patterns 311 and 312 may increase as the frequency of the current increases.

When a width of the surface area of at least one of the first and second coil patterns 311 and 312 increases, a rate of change in which the width of the path narrows may become gentler as the frequency of the current increases. Accordingly, at least one of the first and second coil patterns 311 and 312 may have a wider surface area due to the internal insulating wall 630, thereby reducing effective resistance when the frequency of the current is relatively high.

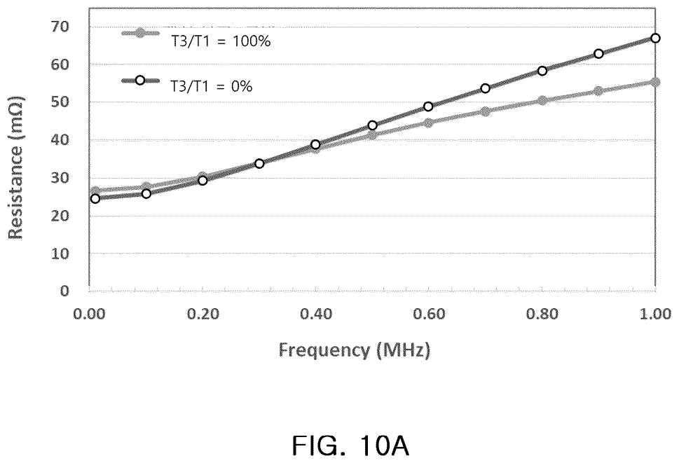

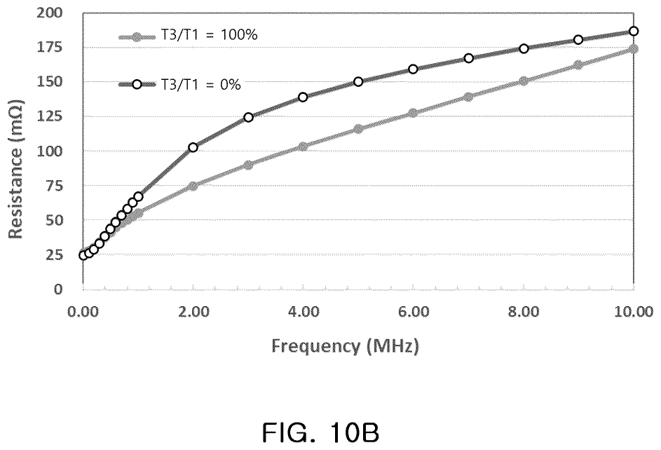

FIGS. 10A and 10B illustrate performance of the coil component in which the total length may be about 2.5 mm, the total width may be about 2.0 mm, the total thickness may be about 0.8 mm, the total number of turns of the first and second coil patterns 311 and 312 may be 7.5, the total number of internal insulating walls 630 in each of the first and second coil patterns 311 and 312 may be three, and the thickness T3 may be 100% (or 0%) of the thickness T1.

Referring to FIGS. 10A and 10B, resistance according to the frequency (e.g., 0.3 MHZ) of current of when the thickness T3 of the internal insulating wall is 100% of the thickness T1 of at least one of the first and second coil patterns 311 and 312 may be smaller than resistance according to the frequency (e.g., 0.3 MHZ) of current of when the thickness T3 of the internal insulating wall is 0% of the thickness T1 of at least one of the first and second coil patterns 311 and 312.

When the current is a DC current (frequency=0 MHZ), the resistance when the thickness T3 is 100% of the thickness T1 may be slightly greater than the resistance when the thickness T3 is 0% of the thickness T1. As the thickness T3 decreases, resistance to DC current (Frequency=0 MHZ) may be reduced.

Total resistance of AC resistance and DC resistance at frequencies of 2 MHz to 6 MHz of a coil component having a thickness T3 of 100% of the thickness T1 may be reduced by about 20% as compared to a coil component having a thickness T3 of 0% of the thickness T1. The total resistance may be reduced by about 27.6% at a frequency of 3 MHZ, the total resistance and the frequency are not limited thereto.

Depending on the circuit using the coil component, the importance of the DC resistance to the DC current and the AC resistance according to the frequency may vary. For example, when the first circuit requires higher AC resistance, the ratio of the thickness T3 to the thickness T1 may be increased. For example, when the second circuit requires a higher DC resistance, the ratio of the thickness T3 to the thickness T1 may be lowered. Thus, there may be an optimum ratio of the thickness T3 to the thickness T1.

Referring to FIGS. 1 to 4, the internal insulating wall 630 may be advantageous in reducing a difference (process dispersion) between a designed optimal ratio of the thickness T3 to the thickness T1 and an actually implemented optimal ratio. Accordingly, the coil component 1000 according to the embodiment may be advantageous in optimizing frequency performance by stably widening the surface area of at least one of the first and second coil patterns 311 and 312.

For example, the thickness T3 of the internal insulating wall 630 may be 25% or more and 75% or less of the thickness T1 of at least one of the first and second coil patterns 311 and 312, and the internal insulating wall 630 may be spaced apart from the first conductive layer 312a. Accordingly, balance between DC resistance and AC resistance may be further optimized.

The insulating resistance of the internal insulating wall 630 may be higher than the insulating resistance of the body 100. For example, the internal insulating wall 630 may include epoxy resin and may not include magnetic powder.

The thickness T3 of the internal insulating wall 630 may be greater than the width Wc of the internal insulating wall 630, and the thickness T1 of at least one of the first and second coil patterns 311 and 312 may be greater than the width Wb. At least one of the first and second coil patterns 311 and 312 may have an aspect ratio higher than one. As the aspect ratio increases, an AC resistance control range according to the thickness T3 of the internal insulating wall 630 may be widened.

For example, a distance (s) between a plurality of turns of at least one of the first and second coil patterns 311 and 312 may be longer than the width Wc of the internal insulating wall 630. As the width Wc of the internal insulating wall 630 decreases, the width of portions surrounding the internal insulating wall 630 in at least one of the first and second coil patterns 311 and 312 may increase, and the DC resistance of the first and second coil patterns 311 and 312 may decrease.

Referring to FIGS. 2, 4 and 6, the coil component 1000 according to the embodiment may further include an insulating film 600 surrounding the coil portion 300 between the coil portion 300 and the body 100.

The insulating film 600 may be configured to insulate the first and second coil patterns 311 and 312 from the body 100, and may include a generally used insulating material such as parylene. Any insulating material may be used for the insulating film 600, and is not limited to any particular example. The insulating film 600 may be formed by vapor deposition, but an embodiment thereof is not limited thereto, and the insulating film 600 may be formed by laminating an insulating film on both surfaces of the support member 200. When the insulating film 600 is formed by vapor deposition, the insulating film 600 may be formed in the form of a conformal film along surfaces of the support member 200 and the first and second coil patterns 311 and 312. When the insulating film 600 is formed by laminating an insulating film, the insulating film 600 may be formed to fill a space between turns of the first and second coil patterns 311 and 312 adjacent to each other. Accordingly, the thickness of the insulating film 600 is not limited to any particular example. As the insulating film 600 is an optional component in the embodiment, when the body 100 may secure sufficient insulating resistance under operating conditions of the coil component according to the embodiment, the insulating film 600 may not be provided.

The internal insulating wall 630 and the insulating film 600 may include different insulating materials. For example, the internal insulating wall 630 may include epoxy resin, and the insulating film 600 may include parylene. The internal insulating wall 630 may form an interfacial surface with the insulating film 600. For example, the internal insulating wall 630 may be formed earlier than the insulating film 600.

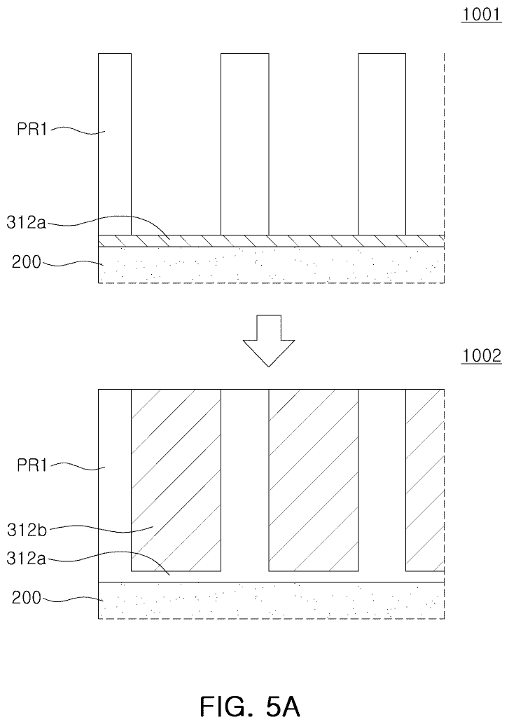

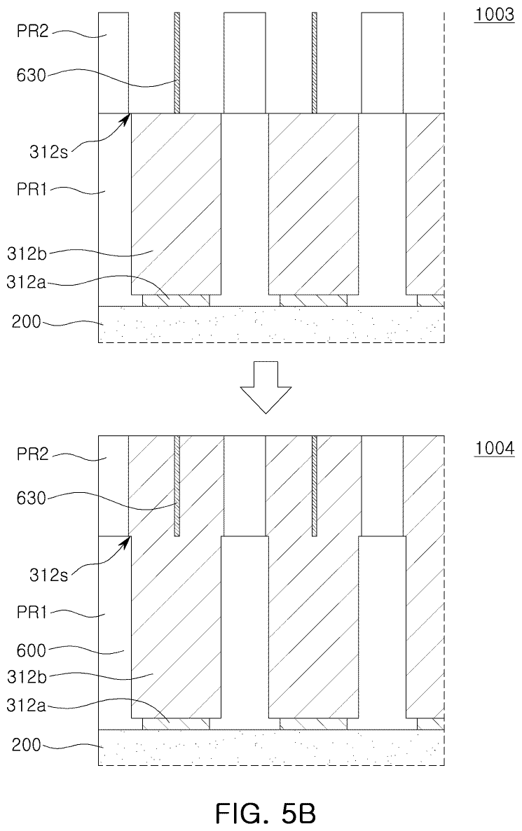

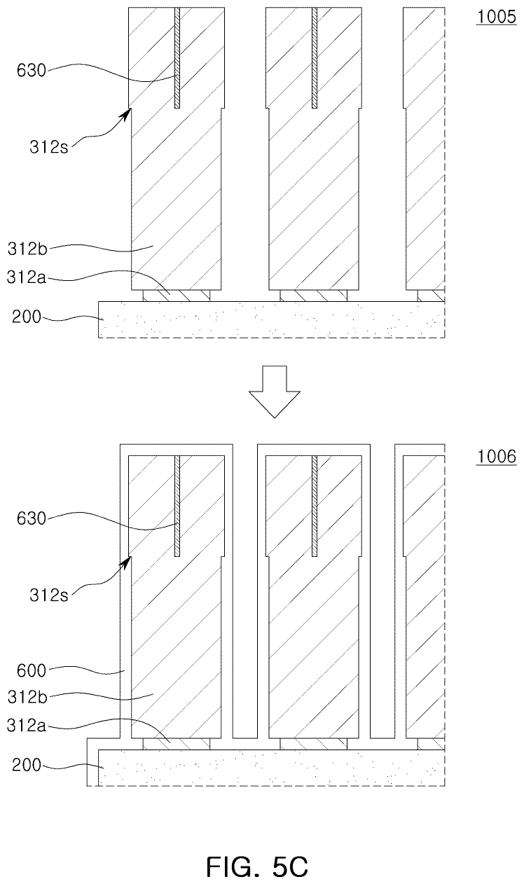

Referring to FIGS. 5A to 5C, the coil component according to the embodiment may be manufactured by performing a first process 1001, a second process 1002, a third process 1003, a fourth process 1004, a fifth process 1005 and a sixth process 1006 in order.

Referring to FIG. 5A, the first process 1001 may be of forming a plating resist PR1 on the support member 200 accompanied by a photolithography process, and the second process 1002 may be of forming a portion of 312b in a space not overlapping the plating resist PR1 on the first conductive layer 312a.

The plating resist PR1 and PR2 may be formed by applying a liquid photosensitive material or laminating a sheet type photosensitive material. The width (or a spacing distance between internal insulating walls adjacent to each other) of the opening of the plating resist PR1 and PR2 may be the width of the first and second coil pattern, and the width of the internal insulating wall may be the spacing distance between the turns of the first and second coil pattern. The thickness of the internal insulating wall may be the height of the first and second coil patterns described above. The plating resists PR1 and PR2 may include a photosensitive insulating material (PID: photoimagable dielectric) delaminated by a delamination solution. For example, the plating resists PR1 and PR2 may include a photosensitive material including a cyclic ketone compound and an ether compound having a hydroxyl group as main components, and the cyclic ketone compound may be, for example, cyclopentanone, and the ether compound having a hydroxyl group may be, for example, poly propylene glycol monomethyl ether. Alternatively, the plating resist PR1 and PR2 may include a photosensitive material including a bisphenol-based epoxy resin as a main component, and the bisphenol-based epoxy resin may be, for example, bisphenol A novolak epoxy resin or bisphenol A diglycidyl ether bisphenol A polymer resin. However, an embodiment thereof is not limited thereto, and any plating resist PR1 and PR2 may be applied as long as delamination may occur by a delamination solution.

Referring to FIG. 5B, a third process 1003 may be of forming a plating resist PR2 and an internal insulating wall 630 accompanied by a photolithography process, and a fourth process 1004 may be of forming the other portion of the second conductive layer 312b in a space not overlapping the plating resist PR2 and the internal insulating wall 630. Here, the side surface of the second conductive layer 312b may have a step difference 312s. The step difference 312s may form a width difference between the upper portion and the lower portion of the second conductive layer 312b. The step difference 312s may indicate that the region in which the step difference 312s is formed on the side surface of the second conductive layer 312b may be configured to be more angular than the other portion of the surface of the second conductive layer 312b. Alternatively, the step difference 312s may indicate that the width of the upper portion of the second conductive layer 312b and the width of the lower portion of the second conductive layer 312b may be configured to be different.

Referring to FIG. 5C, a fifth process 1005 may be etching the plating resist PR1 and PR2. One portion of the first conductive layer 312a may also be etched. The sixth process 1006 may be of forming an insulating film 600.

Referring to FIGS. 4 and 5C, with respect to a cross-sectional surface perpendicular to one surface of the support member 200, one side surface of the first conductive layer 312a may be disposed closer to the center C of the second conductive layer 312b in the width direction than the one side surface of the second conductive layer 312b. Specifically, since the distance from the one side surface of the second conductive layer 312b to the one side surface of the first conductive layer 312a exceeds 0, the one surface may be disposed closer to the center (C) of the second conductive layer 312b in the width direction than one side surface of the second conductive layer 312b. Accordingly, the width Wa of the first conductive layer 312a may be smaller than the width Wb of the second conductive layer 312b. The other side surface of the first conductive layer 312a opposing one side surface of the first conductive layer 312a may be disposed closer to the center C in the width direction of the second conductive layer 312b than the other side surfaces of the second conductive layer 312b. The first conductive layer 312a may be formed by forming the second conductive layer 312b on the seed layer, chemically removing the plating resist using a stripper, and selectively removing the seed layer using a seed etchant. The seed etchant may react with the seed layer and may not react with the electroplating layer which may be the second conductive layer 312b. Accordingly, the first conductive layer 312a formed by selectively removing the seed layer may have a shape in which one side surface is disposed on an inner side than the one side surface of the second conductive layer 312b.

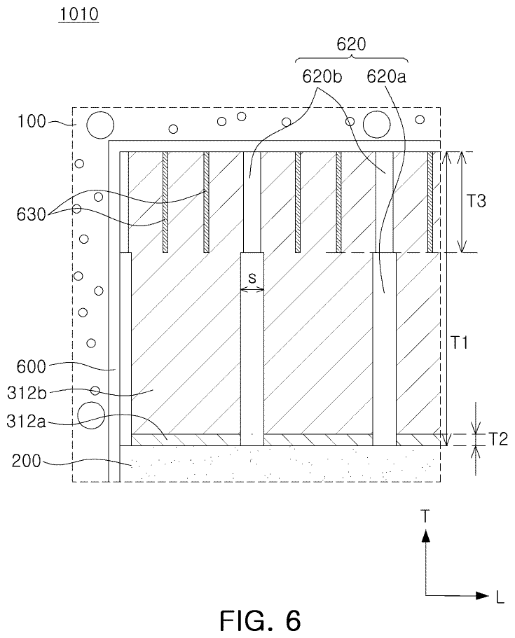

Referring to FIG. 6, the coil portion may further include an insulating external wall 620 disposed between a plurality of turns and spaced apart from the internal insulating wall 630. Accordingly, the distance (s) between the plurality of turns may be decreased efficiently. The insulating external wall 620 may be formed by a similar process as that of forming the plating resist and may not be etched, unlike the plating resist.

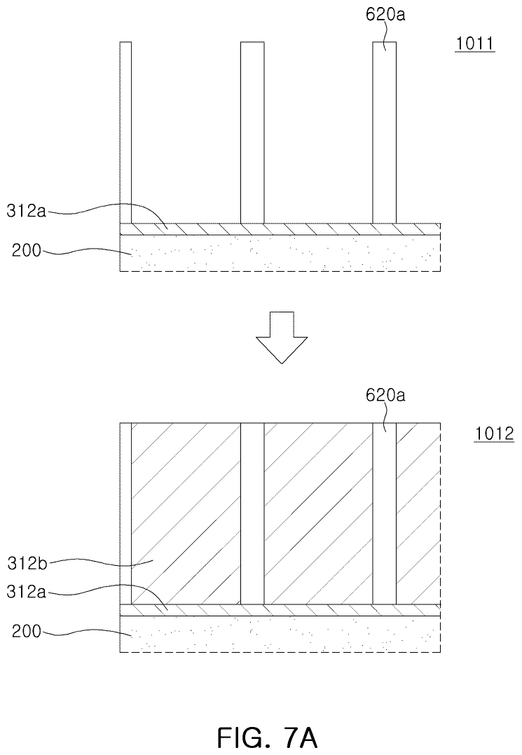

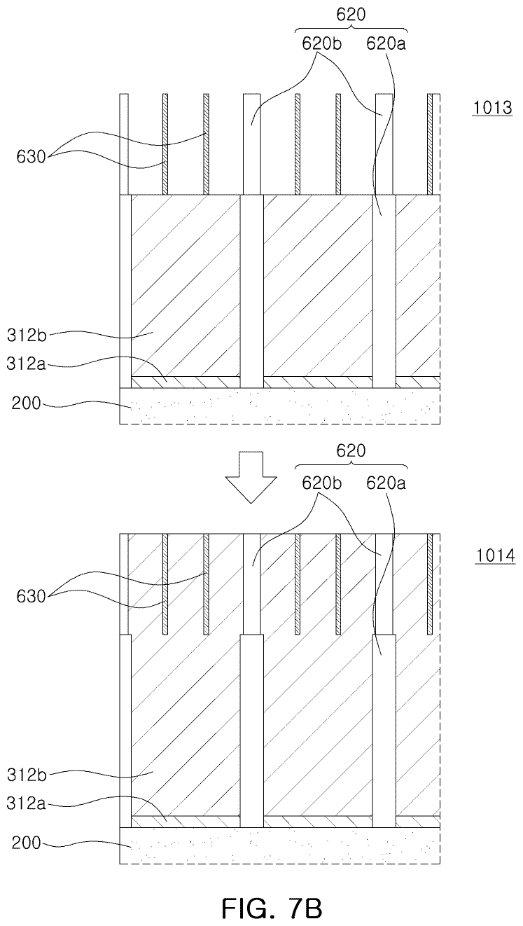

Referring to FIGS. 7A and 7B, the coil component according to the embodiment may be manufactured by performing a first process 1011, a second process 1012, a third process 1013 and a fourth process 1014 in order.

Referring to FIG. 7A, the first process 1011 may be of forming the first portion 620a of the insulating external wall on the support member 200 by accompanying a photolithography process, and the second process 1002 may be of forming a portion of the second conductive layer 312b in a space not overlapping the first portion 620a of the insulating external wall on the first conductive layer 312a.

Referring to FIG. 7B, the third process 1013 may be of forming the second portion 620b of the insulating external wall and the internal insulating wall 630 by accompanying a photolithography process, and the fourth process 1014 may be of forming the other portion of the second conductive layers 312b in a space not overlapping the second portion 620b of the insulating external wall and the internal insulating wall 630. The subsequent processes in FIG. 7B may be similar to the fifth and sixth processes 1005 and 1006 in FIG. 5C.

In embodiments, the forming of the insulating film 600 in FIG. 6 may not be performed, and the coil component 1010 may not include the insulating film 600. Alternatively, when the insulating film 600 in FIG. 6 includes a material different from that of the insulating external wall 620, both the insulating film 600 and the insulating external wall 620 may be formed.

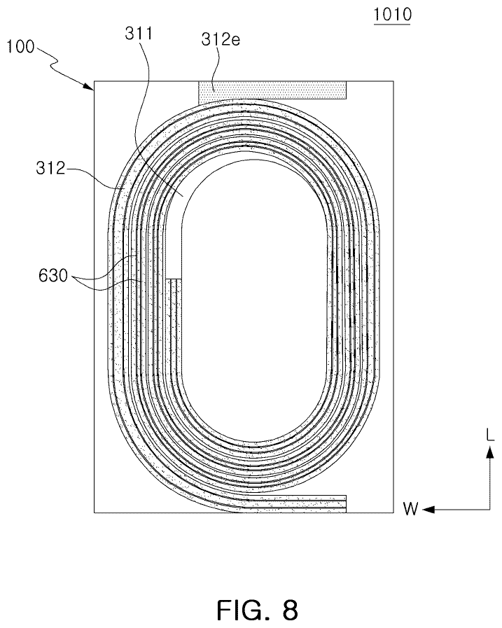

Referring to FIGS. 6 and 8, the internal insulating wall of the coil component 1010 according to the embodiment may be a plurality of internal insulating walls 630 spaced apart from each other in one of the plurality of turns. FIGS. 6 and 8 illustrate a structure in which the number of the plurality of internal insulating walls 630 is two, but the number of the plurality of internal insulating walls 630 may be three or more.

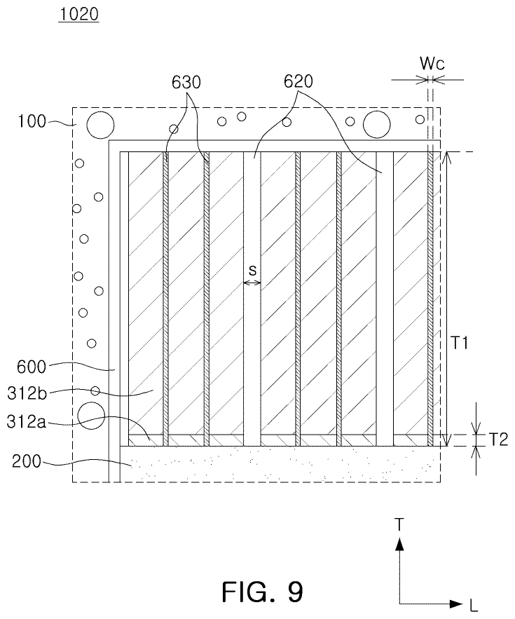

Referring to FIG. 9, a coil portion of a coil pattern 1020 according to the embodiment may include an internal insulating wall 630 dividing at least one of the first and second coil patterns. The thickness T1 of the first and second coil patterns may be the same as that of the internal insulating wall 630. When at least one of the first and second coil patterns includes the first and second conductive layers 312a and 312b, the internal insulating wall 630 may divide each of the first and second conductive layers 312a and 312b. The number of internal insulating walls 630 may be one or more, and the plurality of internal insulating walls 630 may divide the first and second conductive layers 312a and 312b. Here, the dividing by the internal insulating wall 630 may indicate that the internal insulating wall 630 may be continuously formed from a lower surface to an upper surface of at least one of the first and second coil patterns.

The width Wc of the internal insulating wall 630 may be narrower than a distance (s) between a plurality of turns or a width of the insulating external wall 620. Accordingly, the internal insulating wall 630 effectively expand a surface area of at least one of the first and second coil patterns, thereby reducing AC resistance. Also, as the width Wc of the internal insulating wall 630 decreases, the width of portions surrounding the internal insulating wall 630 in at least one of the first and second coil patterns may increase, and the first and second coil pattern DC resistance of may be decreased.

For example, the thickness T1 of at least one of the first and second coil patterns may be greater than a sum (Wd) of the width of at least one of the first and second coil patterns and the width of the internal insulating wall 630. A combination structure of the first and second coil pattern and the internal insulating wall 630 may have an aspect ratio higher than one. As the aspect ratio increases, the AC resistance reduction rate according to the addition of the internal insulating wall 630 may increase.

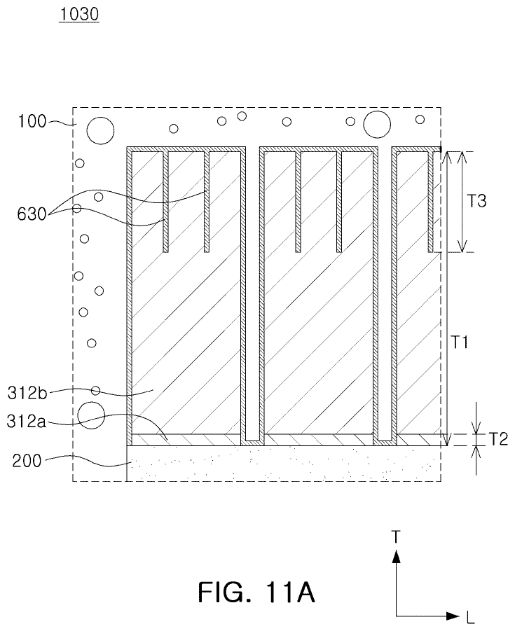

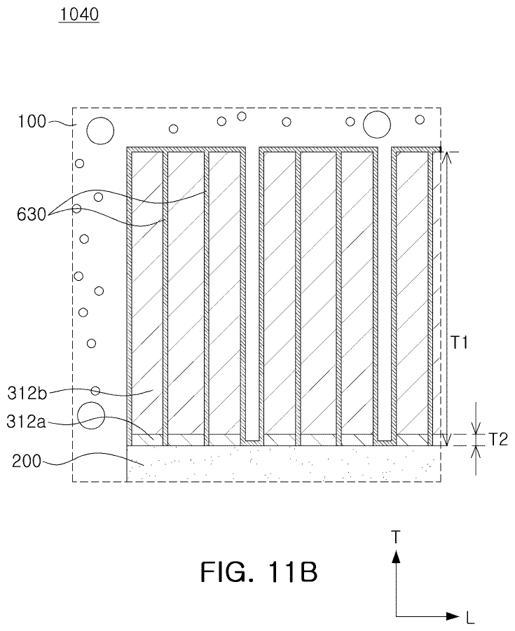

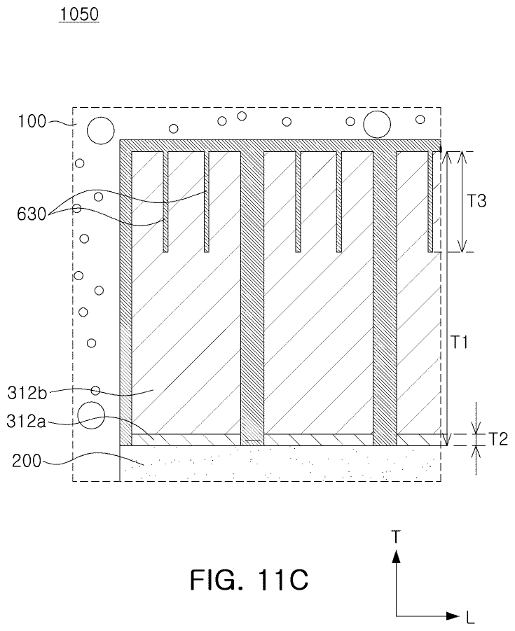

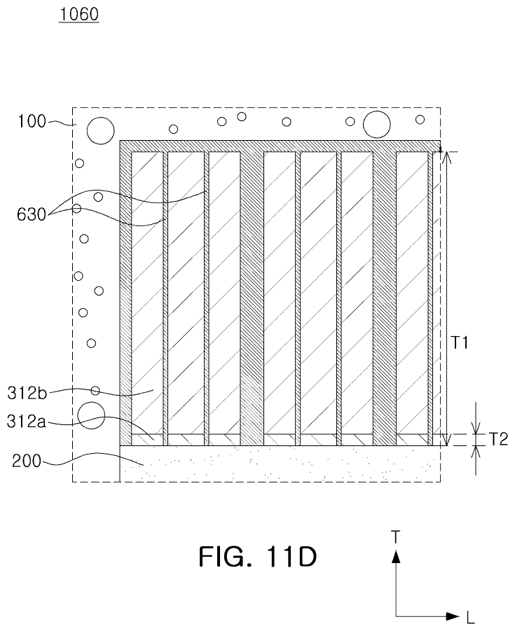

Referring to FIGS. 11A to 11D, the internal insulating wall 630 of the coil component 1030, 1040, 1050, and 1060 according to the embodiment may work as an internal insulating wall, and may also work as an insulating external wall and/or an insulating film.

That is, the first portion of the internal insulating wall 630 may be the internal insulating wall 630 illustrated in FIGS. 6 and 9, the second portion of the internal insulating wall 630 may be an insulating external wall illustrated in FIGS. 6 and 9, and a third portion of the internal insulating wall 630 may be an insulating film illustrated in FIGS. 6 and 9. Since the internal insulating wall 630 in FIGS. 11A to 11D may not have an internal boundary surface, the first, second and third portions of the internal insulating wall 630 may not form a boundary surface therebetween and may include the same insulating material.

Accordingly, since the process of forming the internal insulating wall 630 and the process of forming the insulating external wall and/or the insulating film may not be separated from each other, additionally forming the internal insulating wall 630 may not greatly affect the overall process of the coil component (e.g., difficulty in securing reliability, process cost/time). That is, the internal insulating wall 630 may efficiently improve the degree of freedom in adjusting the surface area of the coil pattern and the degree of freedom in adjusting frequency performance. The surface area of the second conductive layer 312b in FIGS. 11B and 11D may be larger than that of the second conductive layer 312b in FIGS. 11A and 11C.

For example, the internal insulating wall 630 may completely surround the first and second conductive layers 312a and 312b and may prevent the first and second conductive layers 312a and 312b and the body 100 from being in contact with each other.

For example, each portion of the internal insulating wall 630 in FIGS. 11A and 11B may have a relatively thin thickness, and one portion of the internal insulating wall 630 in FIGS. 11C and 11D may have a relatively thick thickness.

T1, T2, T3, Wa, Wb, Wc, Wd, a, c, and s in the embodiment may be an average value of dimension values corresponding to respective portions in the WT cross-sectional surface (or LT cross-sectional surface) of the coil component formed by polishing the coil component in the L direction (or W direction). For example, the WT cross-sectional surface and the LT cross-sectional surface may be applied to analysis using at least one of a transmission electron microscopy (TEM), atomic force microscope (AFM), scanning electron microscope (SEM), optical microscope and surface profiler, and the dimension values may be measured by visual inspection of an image obtained according to the above analysis or by image processing (e.g., identification of pixels based on colors or brightness thereof, filtering pixel values for pixel identification efficiency, integrating distance between identified pixels, and the like). Other methods and/or tools appreciated by one of ordinary skill in the art, even if not described in the present disclosure, may also be used.

The interfacial surface between the internal insulating wall 630 and the insulating film 600 may be measured by cross-sectional surface analysis using TEM, AFM, SEM, an optical microscope and a surface profiler, and a difference in metal materials between the first and second conductive layers 312a and 312b and a difference in insulating materials between the internal insulating wall 630 and the insulating film 600 may be measured by energy dispersive X-ray spectroscopy (EDS) analysis.

According to the aforementioned embodiments, the coil component may be advantageous for optimizing frequency performance by stably widening the surface area of the coil pattern.

While the embodiments have been illustrated and described above, it will be configured as apparent to those skilled in the art that modifications and variations could be made without departing from the scope of the present disclosure as defined by the appended claims.

What is claimed is:

1. A coil component, comprising:
a support member;
a coil portion disposed on at least one of one surface and the other surface of the support member; and
a body embedding the support member and the coil portion,
wherein the coil portion includes a second conductive layer and a first conductive layer disposed between the second conductive layer and the support member, and
wherein the coil portion further includes an internal insulating wall buried in the second conductive layer.

2. The coil component of claim 1,
wherein the coil portion includes at least one of first and second coil patterns respectively disposed on one surface and the other surface of the support member,
wherein the internal insulating wall has a thickness greater than a width of the internal insulating wall, and
wherein a thickness of at least one of the first and second coil patterns is thicker than the width of the at least one of the first and second coil patterns.

3. The coil component of claim 2, wherein the thickness of the internal insulating wall is 25% or more and 75% or less of the thickness of at least one of the first and second coil patterns.

4. The coil component of claim 3,
wherein the first and second conductive layers include different metal materials, and
wherein the internal insulating wall is spaced apart from the first conductive layer.

5. The coil component of claim 4,
wherein at least one of the first and second coil patterns has a plurality of turns, and
wherein a distance between the plurality of turns is longer than the width of the internal insulating wall.

6. The coil component of claim 1,
wherein the first and second conductive layers include different metal materials, and
wherein the internal insulating wall is spaced apart from the first conductive layer.

7. The coil component of claim 1,
wherein the coil portion includes at least one of first and second coil patterns respectively disposed on one surface and the other surface of the support member,
wherein at least one of the first and second coil patterns has a plurality of turns, and
wherein a distance between the plurality of turns is longer than a width of the internal insulating wall.

8. The coil component of claim 7, wherein the internal insulating wall includes a plurality of internal insulating walls spaced apart from each other in at least one of the plurality of turns.

9. The coil component of claim 1, wherein a side surface of the second conductive layer has a step such that there is a difference between a width of an upper portion of the second conductive layer and a width of a lower portion of the second conductive layer.

10. The coil component of claim 1,
wherein the coil portion includes at least one of first and second coil patterns respectively disposed on one surface and the other surface of the support member,
wherein at least one of the first and second coil patterns has a plurality of turns, and
wherein the coil portion further includes an insulating external wall disposed between the turns among the plurality of turns and spaced apart from the internal insulating wall.

11. The coil component of claim 10, further comprising:
an insulating film covering the coil portion and is disposed between the coil portion and the body,
wherein the internal insulating wall and the insulating film include different insulating materials.

12. The coil component of claim 1, wherein the internal insulating wall extends from a lower surface of the second conductive layer to an upper surface of the second conductive layer.

13. The coil component of claim 12, wherein the internal insulating wall extends from a lower surface of the first conductive layer to an upper surface of the first conductive layer.

14. The coil component of claim 13,
wherein the coil portion includes at least one of first and second coil patterns respectively disposed on one surface and the other surface of the support member,
wherein at least one of the first and second coil patterns has a plurality of turns, and
wherein a width of the internal insulating wall is smaller than a distance between the turns among the plurality of turns.

15. The coil component of claim 14, wherein the internal insulating wall includes a plurality of internal insulating walls spaced apart from each other in at least one of the plurality of turns.

16. The coil component of claim 1, further comprising:
an external electrode disposed on the body to be connected to the coil portion,
wherein the body includes magnetic powder and insulating resin.

17. The coil component of claim 1, wherein the internal insulating wall includes epoxy resin.

18. The coil component of claim 1, wherein the internal insulating wall is free of magnetic powder.

19. The coil component of claim 8, wherein the internal insulating wall includes two walls.

20. The coil component of claim 8, wherein the internal insulating wall includes three or more walls.
